(19) United States
(12) Patent Application Publication
(10) Pub. No.: US 2019/0348732 A1
(43) Pub. Date: Nov. 14, 2019

(54) NON-CONTACT TYPE COAXIAL SWITCH

(71) Applicant: Victor H. Nelson, Deer Park, NY (US)

(72) Inventor: Victor H. Nelson, Deer Park, NY (US)

(21) Appl. No.: 15/993,638

(22) Filed: May 31, 2018

Related U.S. Application Data
(60) Provisional application No. 62/670,045, filed on May 11, 2018.

(51) Int. Cl. H01P 1/12

(52) U.S. Cl. CPC H01P 1/125; H01P 1/122

(57) ABSTRACT

A non-contact type coaxial switch that eliminates all contacts and inner conductors. The switch includes a stator/coax base assembly and a rotor. The stator/coax base assembly is fixed, while the rotor is rotatably mounted to the stator/coax base assembly and eliminates all contacts and inner conductors. The rotor is disposed between bearings, and consists of waveguide paths that couple between selected coax connectors. When the rotor is rotated, different selected coax connectors occur. For other arrangements selected, the rotor can switch between a condition of coax and waveguide outputs. The rotor, between bearings, consists of waveguide paths which couple between selected coax connectors. When the rotor is rotated, a different selected coax connector occurs. For other arrangements selected, the rotor can switch between a combination of coax and waveguide outputs.

### CROSS REFERENCE TO RELATED APPLICATIONS

The instant non-provisional patent applications claims priority from provisional application No. 62/670,045, filed on May 11, 2018, entitled NON-CONTACT TYPE COAXIAL SWITCH, and incorporated herein in its entirety by reference thereto.

### BACKGROUND OF THE INVENTION

### Field of the Invention

The embodiments of the present invention relate to a coaxial switch, and more particularly, the embodiments of the present invention relate to a non-contact type coaxial switch to be used at high frequencies when conventional contact type coax switches do not perform as the present invention.

### Description of the Prior Art

Conventional coaxial switches are known to have several limitations. The most severe being power handling capability. The maximum average power that a conventional coaxial switch can handle is typically limited by overheating of the internal switch materials due to RF losses.

Typical Coax Switches use contact bars to transmit the signal between two coax connectors, as shown in FIGS. 1 and 2.

Conventional designs typically exhibit poor thermal conductivity from the transmission line center conductor. Poor thermal conductivity can lead to excessive heat build-up, which can cause the safe operating temperatures of the materials being used to be exceeded resulting in failures.

Further, the peak power of conventional coaxial switches are limited by multipacting breakdown. Multipacting breakdown is a resonant radio frequency discharge that is attributable to secondary emissions of electrons from discharging surfaces when a radio frequency field of sufficient magnitude and proper frequency is applied across a gap in a vacuum. Multipacting causes disruption of communications and if not controlled can lead to destruction of the switch.

Many coaxial switches of conventional design are inclined to suffer from multipacting breakdown at low power levels and certain (i.e. L and C) frequency ranges. As a result, many current applications are increasingly requiring power handling capabilities beyond those of such conventional coaxial switches.

Conventional coaxial switches are also generally more mechanically complex than other designs. As a result, many switch configurations, though realizable, are difficult and costly to implement in a conventional coaxial design.

In the communication or Military Industries, there is a need for reliable coaxial switches in frequency bands beyond 25 GHz and the need for handling higher power. Contact devices are vulnerable to repeat consistent performance.

Existing coax switches with contacts fall short in performance at frequencies beyond 30 GHz. Often for switching they must use a waveguide switch at these frequencies.

As shown in FIGS. 2A and 2B, typical waveguide transfer switches use a waveguide rotor moving inside a waveguide housing to transfer microwave energy between two waveguide ports.

Conventional coax switches, with contacts, have various limitations at high frequencies exceeding 20 GHz. They suffer from:
Performance loss, high VSWR, and low isolation; all key parameters of quality switches;
Reliability—contacting devices at these frequencies introduce erratic results;
High power concerns. Contacts in typical switches are prone to overheat, weld together, arc, or become intermittent, limiting the RF power applied or producing undesired results;
Peak power concerns—Contact devices are prone to arcing or multipacting or adding undesired noise into transmission intelligence;
Life—The requirement for frequent switching is limited to as a result of contacting self-destruction;
RF High Frequency and modest to high RF power—the industry is forced to use waveguide switches with bulky wave guides, leading to size and complexity;

In contradistinction, however, the embodiments of the present invention allow industry to use coaxial lines, rather than waveguides, to feed the switching device, described herein, whose principle switching means is s waveguide switch, which eliminates the various problems of high frequency coaxial switches of the typical design.

Numerous innovations for coaxial switches have been provided in the prior art, which are adapted to be used, and which are discussed, infra, in chronological order to show advancement in the art. Even though these innovations may be suitable for the specific individual purposes to which they address, they would not be suitable for the purposes of the embodiments of the present invention as heretofore described, namely, a non-contact type coaxial switch. For example:

### DowKey Microwave Switch and RF Relay

The Type HO Coaxial Transfer Switches have RF geometry optimized for 3.5 mm connectors over a 0-26.5 GHz frequency band. The latching model is magnetically latched, and can be with or without an actuator cutoff circuit. Both latching and failsafe models can be with or without indicators.

A single voltage pulse of 20 milliseconds is required to change positions. No holding power is required to maintain a position.

The failsafe model includes a dual magnetic field. The Type HO Coaxial Transfer Switches have limited and deteriorative performance, and for a contact type coax switch, has a frequency limit of 26.5 GHz.

The performance of DowKey deteriorates >20 GHz, while the present invention provides excellent results for 26-40 GHz.

In contradistinction, however, the embodiments of the present invention are a non-contact type coax switch that can operate in a range of 26-40 GHz, and with small changes in the rotor, can handle other frequency ranges.

### U.S. Pat. No. 2,697,767 to Charles

U.S. Pat. No. 2,697,767—issued to Charles on Dec. 21, 1954 in U.S. class 200 and subclass 155—teaches a radio frequency switch. The switch includes a switch body having therein a socket with a metallic surface, at least two radio frequency line connections in an axially aligned position in the switch body extending to the socket surface, and a movable switch member having a longitudinally extended open sided metallic walled radio frequency line cavity therein arranged to connect two of the radio frequency line connections in one switch position. The member is mounted in the socket and together with the metallic socket surface provides in the one switch position an enclosed radio frequency line of uniform impedance with the metallic socket surface forming a continuous unbroken longitudinal portion of the boundary of the line and with the outer peripheral edge of the cavity substantially flush throughout its entire length with the switch body in the one switch position, so that the switch provides in the one position a radio frequency line of uniform impedance throughout its length with a continuous conducting path along the boundary of the line.

### U.S. Pat. No. 2,749,524 to Derosa

U.S. Pat. No. 2,749,524—issued to Derosa on Jun. 5, 1956 in U.S. class 333 and subclass 97—teaches a switching device for coupling high frequency electromagnetic energy sequentially between a given one and the others of a plurality of coaxial connectors. The switch device includes a conductor body having an extended surface connected to the outer conductors of the coaxial connectors, a plurality of sector conductors and apparatus disposing the sector conductors in close spaced substantially parallel relation to the surface. The spacing of the sector conductors, with respect to the surface, is a fraction of the radial spacing of the inner and outer conductors of the coaxial connectors. The switch device further includes apparatus coupling each of the sector conductors to the inner conductor line of the coaxial connectors and a movable conductor coupled to the inner conductor of the given connector for movement in coupled relation to the sector connectors to electrically couple the sector conductors sequentially to the given connector.

Derosa et al. uses contacts to switch energy.

In contradistinction, however, the embodiments of the present invention use no contacts or conductors coupled to contacts. The embodiments of the present invention have a waveguide rotor changes switching paths not utilizing sector conductors as used by Derosa et al.

### U.S. Pat. No. 4,908,589 to Basil Jr. et al.

U.S. Pat. No. 4,908,589—issued to Basil Jr. et al. on Mar. 13, 1990 in U.S. class 333 and subclass 106—teaches a dielectrically loaded waveguide switch that provides high power handling capability, small size, and low weight. The switch includes first and second dielectrically loaded waveguides selectively connected by a switch. In a specific embodiment of the switch, the switch includes a third dielectrically loaded waveguide mounted for communication with the first and second waveguides upon switch actuation.

Basil teaches a typical coax switch with 4 adaptions mounted to a typical w.g. switch with dielectric loading.

In contradistinction, however, the embodiments of the present invention teach coax outputs as a part of a w.g. structure consisting of mini-rotors to produce an inherent device that is much smaller with better performance to produce a true coaxial switch. Further, the embodiments of the present invention are small coaxial switches with no contacting apparatus, higher power capability, extended frequency application, and outstanding reliability.

Basil is a typical coax with four adaptors mounted to a typical w,g, switch with dielectric loading.

In contradistinction, however, the embodiments of the present invention provide coax outputs, a part of a w.g. structure consisting of mini-rotors to provide an inherent device, which is much smaller with better performance. The embodiments of the present invention are true coax switches.

The embodiments of the present invention are small coax switches with the following:
No contacting apparatus;
Higher power capability;
Extended frequency application up to 40 GHz;
Outstanding reliability as a result of no contacting;
A range limited to the range of the w.g. rotor path;
A w.g. path designed for high frequencies (26 GHz to 40 GHz), where typical coax switches falter;
Coax inputs are internally part of the w.g. assembly;
The w.g. switch has rotors to accommodate coaxial inputs;
Full RF power capability as to element contacts; and
Various configurations, including all coax or some waveguide connections.

### U.S. Pat. No. 4,967,170 to Hettlage et al.

U.S. Pat. No. 4,967,170—issued to Hettlage et al. on Oct. 30, 1990 in U.S. class 333 and subclass 106—teaches a waveguide switch with four outputs or inputs normally having one rotor with three passages with which, as appropriate, two waveguide connections can be effected in specific rotor positions. In two switching positions only the central waveguide passage conducts HF signals, whereas in the two other switching positions both curved passages simultaneously conduct HF signals. Whereas, the transmission losses in the central passage are low, a very high reflection level has hitherto been obtained in the two curved passages because of the points of inflexion. In order to improve the transmission characteristics, the curved passages have an elliptical shape. For this, the longitudinal passage is narrowed toward the central point of the rotor, so that sufficient space is provided for the curved portion of the lateral passages. The circular shape of the curved passages can also be approximated by a facet-like shaping of the sidewalls. The points of inflexion thus created result in only insignificant changes in the transmission characteristics.

Hettlage et al. is an ordinary w.g. switch having full walls with inherent tuning. It is not applicable to the embodiments of the present invention, and is for a contact coaxial switch.

### U.S. Pat. No. 5,451,918 to Sun

U.S. Pat. No. 5,451,918—issued to Sun on Sep. 19, 1995 in U.S. class 335 and subclass 4—teaches a microwave multi-port switch having three operating positions and three RF paths. Six peripheral contact junctions are provided adjacent corners of a hexagonal cavity in an RF body and a common contact is provided at the cavity center. Six reeds bridge over in and out of contact with adjacent ones of the peripheral contacts, and six reeds extend between and in and out of contact with the peripheral contacts and the common contact. Reeds are actuated by movement of a coil-driven rocker through three actuating mechanisms, including a center post at three levels above the body. The mechanisms include radially extending leaf springs, an actuator loosely keyed to the center post, and a pivoted leaf spring movable by rocker tilting depressing the actuator. The leaf springs and fixed dielectric posts extend upwardly from the reeds.

Sun is a contact-type coaxial switch.

In contradistinction, however, the embodiments of the present invention eliminate all contacts and inner conductors, and as such, there is no physical contacts to operate the coax switch. Switching the w.g path allows coupling to other paths therewithin.

### U.S. Pat. No. 5,519,253 to Lake et al.

U.S. Pat. No. 5,519,253—issued to Lake et al. on May 21, 1996 in U.S. class 257 and subclass 724—teaches a low inductance coaxial semiconductor switching module and methods of operating same. The module can contains high power, high frequency semiconductor switching device, operated to provide high power at low inductance. The module incorporates compositional geometrical and electrical symmetry in a coaxial configuration. The module also includes short internal leads, a special circumferential array of substrates, a special circular gate circuit, a special circular Kelvin circuit, a special terminal subassembly, and special module mounting features.

Lake ('253) is a solid state switch using semiconductors to open or close electronically to provide switching. It has high speed and is very loose.

In contradistinction, however, the embodiments of the present invention are non-contact type coaxial switches; entirely different structures.

### U.S. Pat. No. 5,563,447 to Lake et al.

U.S. Pat. No. 5,563,447—issued to Lake et al. on Oct. 8, 1996 in U.S. class 257 and subclass 724—teaches a high power module containing high power, high frequency semiconductor switching devices and methods of operating same that provide high power and low inductance. The module incorporates compositional, geometrical and electrical symmetry. The module also includes short internal leads, special IC chip substrates, trimmable gate lead resistances, a special composite metal/ceramic baseplate, and a special terminal conductor overlap.

Lake ('447) is a solid state switch using semiconductors accommodating various circuitry and DC power.

### U.S. Pat. No. 6,667,671 to Speldrich et al.

U.S. Pat. No. 6,667,671—issued to Speldrich et al. on Dec. 23, 2003 in U.S. class 333 and subclass 106—teaches a waveguide switch having a stator and an electrically conducting movable element. The stator has waveguide paths between waveguide terminal pairs. Each path is switchable to conducting or nonconducting with the help of the movable element for high-frequency waves. To permit lower requirements regarding manufacturing tolerances, the movable element is designed as a septum in a gap in the stator and extends in the waveguide path that is switched to nonconducting, in parallel to its E plane. This divides the waveguide path into two partial waveguides that run in parallel with one another, and in comparison with the switched-to-conducting state of the waveguide path, have smaller cut-off wavelengths, and an electrically conducting movable element. The stator has waveguide paths between waveguide terminal pairs. Each path is switchable to conducting or nonconducting with the help of the movable element for high-frequency waves. To permit lower requirements regarding manufacturing tolerances, the movable element is designed as a septum in a gap in the stator and extends in the waveguide path that is switched to nonconducting, in parallel to its E plane. This divides the waveguide path into two partial waveguides that run in parallel with one another, and in comparison with the switched-to-conducting state of the waveguide path, have smaller cut-off wavelengths.

Speldrich et al. is purely a w.g. switch with no inherent coax capability and requires adding additional coax adapters to provide coax switching.

It is apparent that numerous innovations for coaxial switches have been provided in the prior art, which are adapted to be used. Furthermore, even though these innovations may be suitable for the specific individual purposes to which they address, however, they would not be suitable for the purposes of the embodiments of the present invention as heretofore described, namely, a non-contact type coaxial switch.

### SUMMARY OF THE INVENTION

Thus, an object of the embodiments of the present invention is to provide a non-contact type coaxial switch, which avoids the disadvantages of the prior art.

The present invention has no magnetic contact, but has a rotating waveguide rotor in its place.

The non-contact type coaxial switch is essentially a coax switch that does not use any contact bars to transfer the microwave energy between two coax connectors, it uses a rotor similar to a waveguide one to transfer the signal between two coax connectors. The coax connectors work like an antenna and send the signal through the waveguide channel to the receiving connector.

Combining the signal between and after a waveguide transfer switch involves 3 devices and is quite complex. Using a typical coax switch has its downfalls in terms of not being able to handle high power and is very loosy at high frequencies above 30 GHz. In contradistinction, however, the non-contact type coaxial switch of the present invention is a compact device that allows for such switching capability above 26.5 GHz while being small and light weight. Unlike typical coax switches it has a huge advantage of being contactless and more reliable at high frequencies and at high power.

In another embodiment the non-contact type coaxial switch of the present invention has the capability of switching between one or more waveguide port(s) and coax input(s)/output(s). A plurality of possible combinations can be achieved by the non-contact type coaxial switch of the present invention whereby the switch is not only switching between two paths but these paths do not have to be the same, e.g. a waveguide port or a coax connector.

The bottom housing of the non-contact type coaxial switch of the present invention has a waveguide rotor that pivots inside and can be either a fully-fledged rotor or one that has one or more of its sides cut out.

Briefly stated, another object of the embodiments of the present invention is to provide a non-contact type coaxial switch that eliminates all contacts and inner conductors. The switch includes a stator/coax base assembly and a rotor. The stator/coax base assembly is fixed, while the rotor is rotatably mounted to the stator/coax base assembly and eliminates all contacts and inner conductors. The rotor is disposed between bearings, and consists of waveguide paths that couple between selected coax connectors. When the rotor is rotated, different selected coax connectors occur. For other arrangements selected, the rotor can switch between a condition of coax and waveguide outputs.

Still another object of the embodiments of the present invention is to replace contact type devices with non-contact type devices that provide higher power capability, along with reliable and repeatable performance.

Yet another object of the embodiments of the present invention is to supply a waveguide switch with internal coaxial outputs.

Still yet another object of the embodiments of the present invention is to make use of a rotor without the additional side in both the E plane and the H plane waveguide configurations for smaller size units.

Yet still another object of the embodiments of the present invention is that the coaxial concept will work well with a full rotor concept (a larger version) as well as the 3 sided rotor path.

Still yet another object of the embodiments of the present invention is that SMI has developed a combination of a waveguide switch with suitable coaxial outputs or non-contact device.

Yet still another object of the embodiments of the present invention is the formation of a “Cowave” switch which allows for switching at higher frequencies with excellent performance. With one such a switch, one can choose between a combination of waveguide ports or coaxial outputs.

Still yet another object of the embodiments of the present invention is to expand the switch options to include:
1. Non-contact coax switch;
2. Waveguide switch; and
3. The new Cowave that is a hybrid between the above two switches.

The novel features considered characteristic of the embodiments of the present invention are set forth in the appended claims. The embodiments of the present invention themselves, however, both as to their construction and to their method of operation, together with additional objects and advantages thereof, will be best understood from the following description of the embodiments of the present invention when read and understood in connection with the accompanying figures of the drawing.

### BRIEF DESCRIPTION OF THE FIGURES OF THE DRAWING

The figures of the drawing are briefly described as follows:

FIG. 1A is a diagrammatic top plan view of a typical Coax base for a double pole double throw coax transfer switch by SMI without contact bars;

FIG. 1B is a diagrammatic top plan view of a typical Coax base for a double pole double throw coax transfer switch by SMI with contact bars;

FIG. 2A is diagrammatic perspective view of a typical SMI WR34 Waveguide Transfer Switch;

FIG. 2B is an enlarged diagrammatic perspective view of a typical waveguide housing showing two waveguide ports;

FIG. 3A is a diagrammatic perspective view of a typical Waveguard rotor rotating between two positions inside a waveguide housing for a double pole double throw WR34 Waveguide Transfer Switch;

FIG. 3B is a diagrammatic top plan view taken in the direction of ARROW 3B in FIG. 3A of a typical Waveguard rotor rotating between two positions inside a waveguide housing for a double pole double throw WR34 Waveguide Transfer Switch;

FIG. 4 is a diagrammatic perspective view of the non-contact coaxial switch of the embodiments of the present invention showing two coax connectors and two waveguide ports facing each other;

FIG. 5 is a reduced diagrammatic side elevational view taken in the direction of ARROW 5 in FIG. 4 of the non-contact type coaxial switch of the embodiments of the present invention;

FIG. 6 is a reduced diagrammatic front elevational view taken in the direction of ARROW 6 in FIG. 4 of the non-contact type coaxial switch of the embodiments of the present invention;

FIG. 7 is a reduced diagrammatic top plan view taken in the direction of ARROW 7 in FIG. 4 of the non-contact type coaxial switch of the embodiments of the present invention;

FIG. 8 is a reduced diagrammatic bottom plan view taken in the direction of ARROW 8 in FIG. 4 of the non-contact type coaxial switch of the embodiments of the present invention;

FIG. 9 is a reduced diagrammatic top plan view taken in the direction of ARROW 9 in FIG. 4 of the non-contact type coaxial switch of the embodiments of the present invention;

FIG. 10 is a diagrammatic cross sectional view taken along LINE 10-10 in FIG. 4;

FIG. 11A is a diagrammatic cross sectional view illustrating the two waveguide ports and 2 coax connectors;

FIG. 11B is a diagrammatic cross sectional view illustrating the 3 connectors with one waveguide port configuration;

FIG. 12 is a diagrammatic cross sectional view illustrating the rotor and the housing with 2 waveguide ports;

FIG. 13A is a diagrammatic cross sectional view of the present invention illustrating the flow of energy inside the housing from a coax to a coax; and

FIG. 13B is a diagrammatic cross sectional view of the present invention illustrating the flow of energy inside the housing from a coax to a waveguide port.

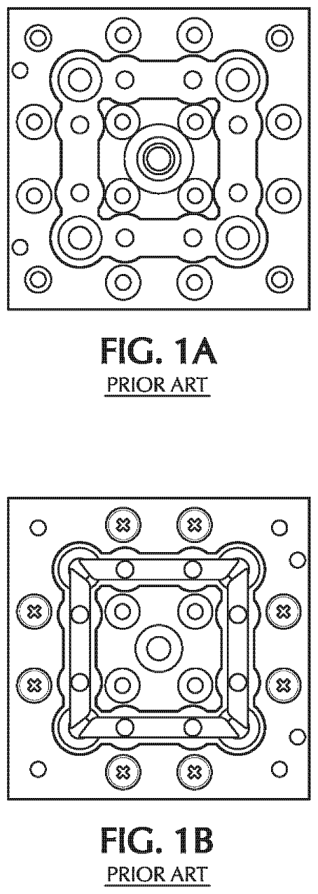

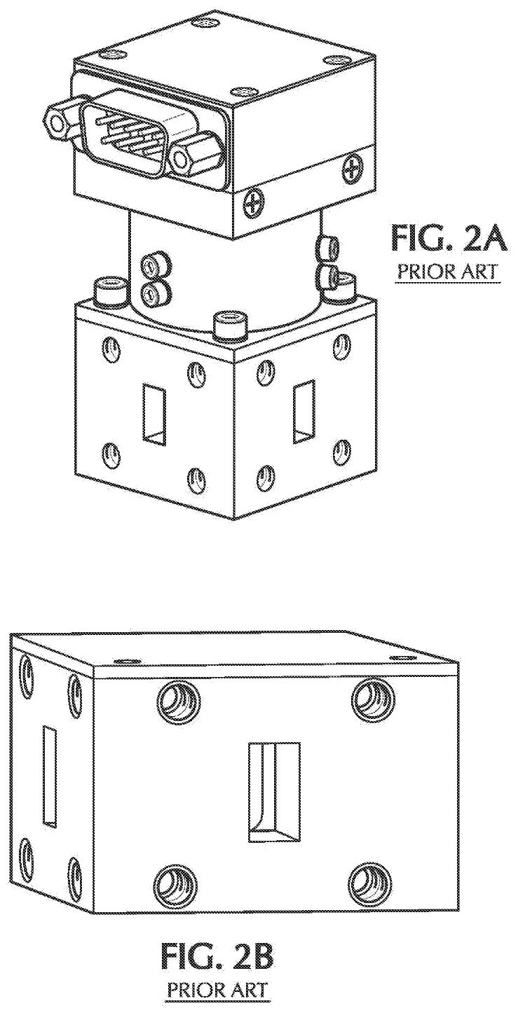

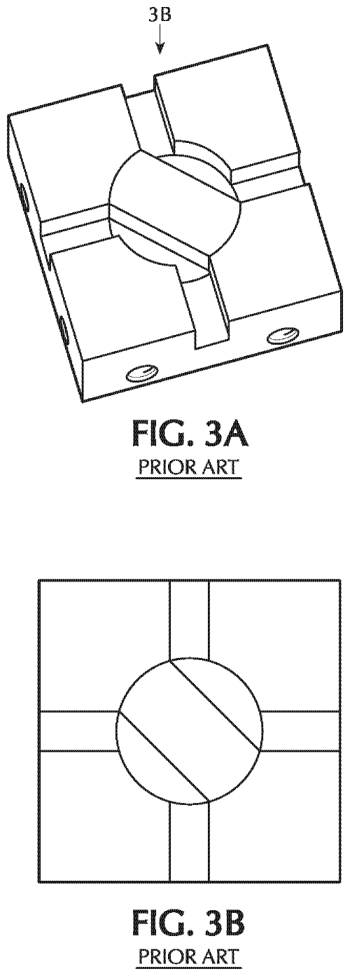

### LIST OF REFERENCE NUMERALS UTILIZED IN THE FIGURES OF THE DRAWING

### Introductory

20 non-contact type coaxial switch of embodiments of present invention

### Overall Configuration of Non-Contact Type Coaxial Switch 20

| | |
|---|---|
| 22 | stator/coax base assembly |
| 24 | rotor |

### Specific Configuration of Stator/Coax Base Assembly 22

| | |
|---|---|
| 26 | coax base of stator/coax base assembly 22 for resting on support |
| | surface 34 |
| 28 | connectors for engaging with coaxial cable ends, respectively, |
| | including poles and throws |
| 30 | hex nuts |
| 32 | flat head screws |
| 34 | support surface |

### Specific Configuration of Rotor 24

| | |
|---|---|
| 36 | waveguide ports of rotor 24 |
| 38 | bearings of rotor 24 |
| 40 | housing of rotor 24 |

### DETAILED DESCRIPTION OF THE PREFERRED EMBODIMENTS

### Introductory

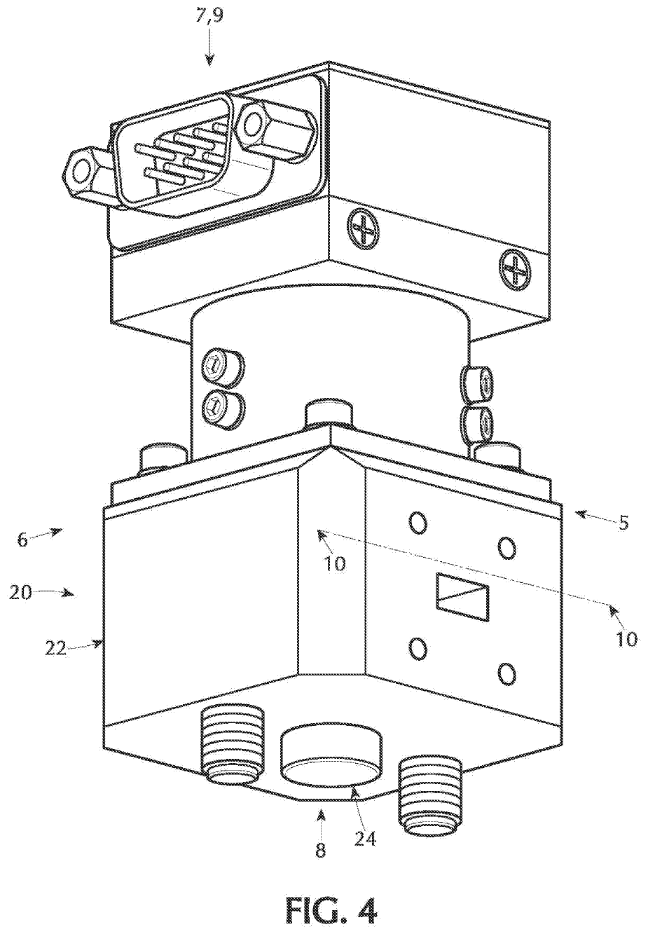

Referring now to the figures, in which like numerals indicate like parts, and particularly to FIG. 4, the non-contact type coaxial switch of the embodiments of the present invention is shown generally at 20.

### The Overall Configuration of the Non-Contact Type Coaxial Switch 20

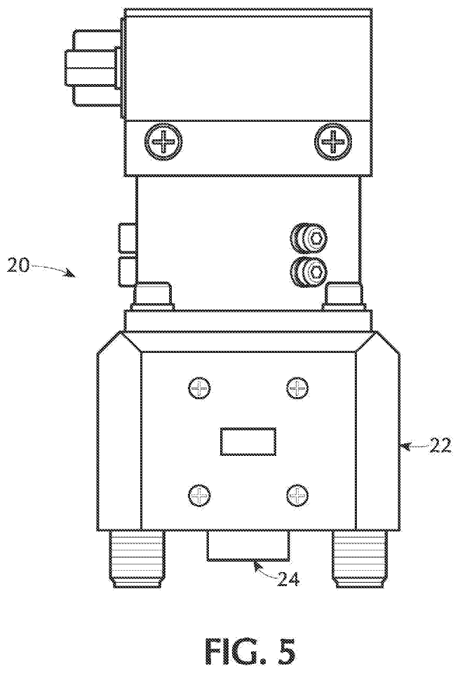

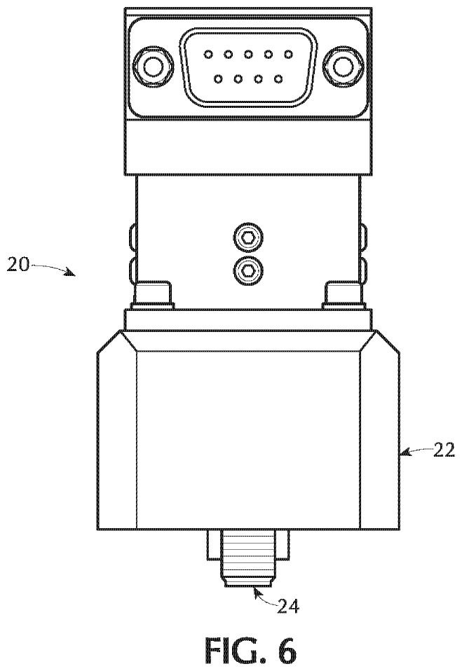

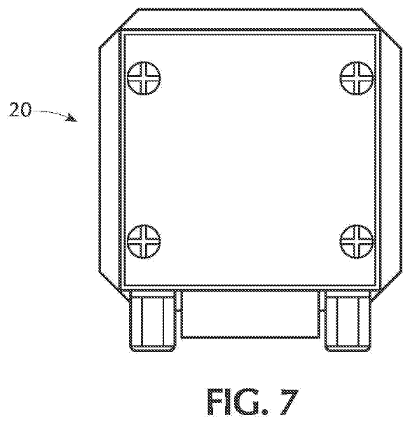

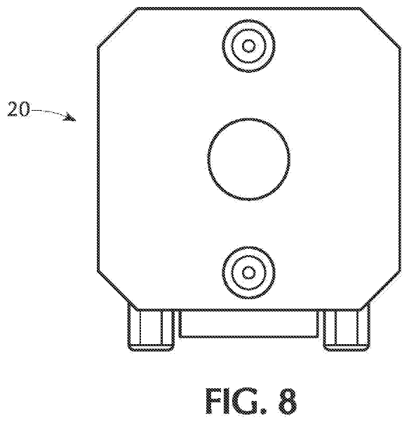

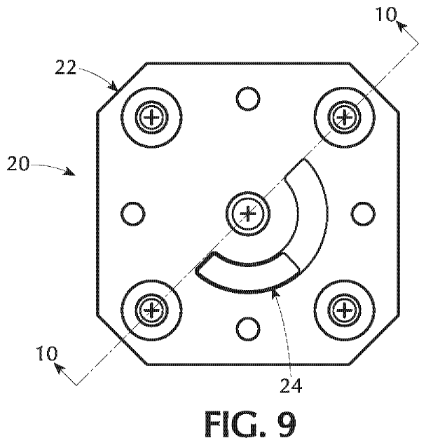

The overall configuration of the non-contact type coaxial switch 20 can best be seen in FIGS. 4-10, and as such, will be discussed with reference thereto.

The non-contact type coaxial switch 20 comprises a stator/coax base assembly 22 and a rotor 24. The stator/coax base assembly 22 is fixed. The rotor 24 is rotatably mounted to the stator/coax base assembly 22.

The non-contact type coaxial switch 20 is one of a complete coax switch and a waveguide switch, and arrangements therebetween.

### The Specific Configuration of the Stator/Coax Base Assembly 22

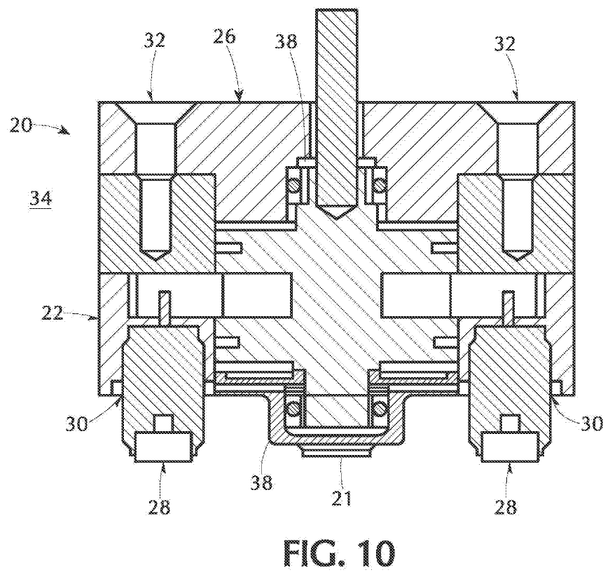

The specific configuration of the stator/coax base assembly 22 can best be seen in FIG. 10, and as such, will be discussed with reference thereto.

The stator/coax base assembly 22 is external to the rotor 24 for user's use.

The stator/coax base assembly 22 includes a coax base 26, connectors 28, hex nuts 30, and flat head screws 32.

The coax base 26 of the stator/coax base assembly 22 is for resting on a support surface 34. The connectors 28 of the stator/coax base assembly 22 are for engaging with coaxial cable ends, respectively, including poles and throws. The hex nuts 30 of the stator/coax base assembly 22 secure the connectors 28 of the stator/coax base assembly 22 to the coax base 26 of the stator/coax base assembly 22. The flat head screws 32 of the stator/coax base assembly 22 secure the non-contact type coaxial switch 20 together.

### The Specific Configuration of the Rotor 24

The specific configuration of the rotor 24 can best be seen in FIGS. 10, 11A, 11B, 12, 13A, and 13B, and as such, will be discussed with reference thereto.

As shown in FIG. 10, the rotor 24 is internal to the stator/coax base assembly 22, and rotates on bearings 38.

The rotor 24 is a waveguide that performs a switching function so as to allow for the non-contact and no inner conductors 20.

The rotor 24 is a section of the waveguide that is rotated between the coax connectors 28 of the stator/coax base assembly 22 to complete circuit.

The rotor 24 can be one of vertical (E plane) and horizontal (H plane), with the non-contact type coaxial switch 20 designed accordingly.

The rotor 24 is capable to switching to feed the coax outputs to form a waveguide switch with internal coax outputs.

A typical w.g. switch is a w.g. rotor that switches to input the waveguide to the w.g. outputs.

Below are 5 randomly picked examples that the non-contact type coaxial switch 20 can assume:

### Example 1

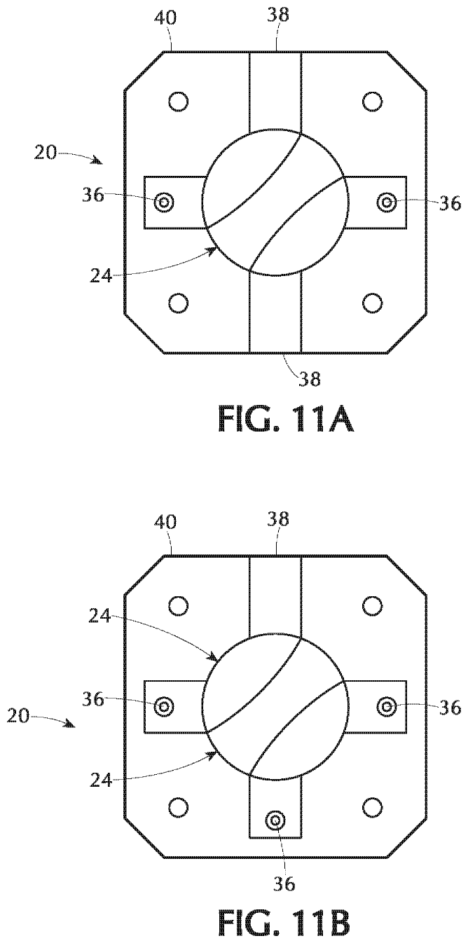

As shown in FIG. 11A, the non-contact type coaxial switch 20 has two waveguide ports 36 and 2 coax connectors.

### Example 2

As shown in FIG. 11B the non-contact type coaxial switch 20 has 3 coax connectors with 1 waveguide port configuration.

### Example 3

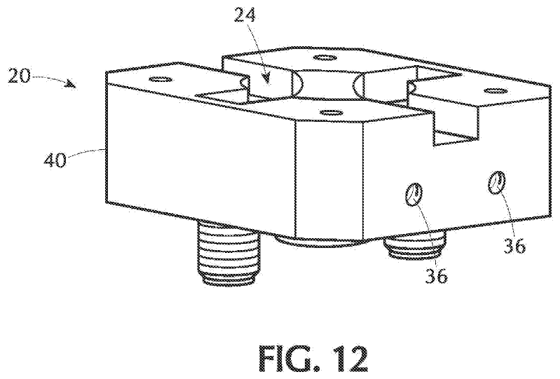

As shown in FIG. 12, the non-contact type coaxial switch 20 has the rotor 24 and the housing 40 with 2 waveguide ports 36.

### Example 4

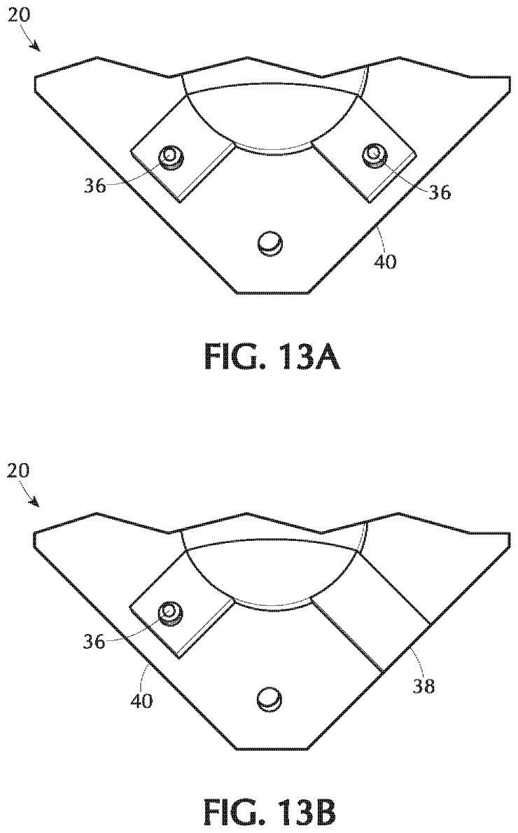

As shown in FIG. 13A, the non-contact type coaxial switch 20 has the flow of energy inside the housing 40 from a coax to a coax.

### Example 5

As shown in FIG. 13B, the non-contact type coaxial switch 20 has the flow of energy inside the housing 40 from a coax to a waveguide port.

### Impressions

It will be understood that each of the elements described above, or two or more together, may also find a useful application in other types of constructions differing from the types described, supra.

While the embodiments of the present invention have been illustrated and described as embodied in a non-contact type coaxial switch, nevertheless, they are not limited to the details shown, since it will be understood that various omissions, modifications, substitutions, and changes in the forms and details of the embodiments of the present invention illustrated, and their operation, can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A non-contact type coaxial switch for eliminating all contacts and inner conductors, comprising:
a) a stator/coax base assembly; and
b) a rotor;
wherein said stator/coax base assembly is fixed;
wherein said rotor is rotatably mounted to said stator/coax base assembly; and
wherein said rotor is for eliminating all of the contacts and the inner conductors.

2. The non-contact type coaxial switch of claim 1, wherein said non-contact type coaxial switch is one of a complete coax switch, a waveguide switch, and arrangements therebetween.

3. The non-contact type coaxial switch of claim 1, wherein said stator/coax base assembly is external to said rotor for user's use.

4. The non-contact type coaxial switch of claim 2, wherein said stator/coax base assembly includes:
a) a coax base;
b) connectors;
c) hex nuts; and
d) flat head screws;
wherein said coax base of said stator/coax base assembly is for resting on a support surface;
wherein said connectors of said stator/coax base assembly are for engaging with coaxial cable ends, respectively, including poles and throws;
wherein said hex nuts of said stator/coax base assembly secure said connectors of said stator/coax base assembly to said coax base of said stator/coax base assembly; and
wherein said flat head screws of said stator/coax base assembly secure said non-contact type coaxial switch together.

5. The non-contact type coaxial switch of claim 1, wherein said rotor is internal to said stator/coax base assembly.

6. The non-contact type coaxial switch of claim 4, wherein said rotor is a waveguide that performs a switching function so as to allow for said non-contact and said no inner conductors.

7. The non-contact type coaxial switch of claim 6, wherein said rotor is a section of said waveguide that is rotated between said connectors of said stator/coax base assembly to complete circuit.

8. The non-contact type coaxial switch of claim 1, wherein said rotor is one of vertical (E plane) and horizontal (H plane), with said non-contact type coaxial switch designed accordingly.

9. The non-contact type coaxial switch of claim 6, wherein said waveguide of said rotor switches to feed coax outputs to form said waveguide switch with internal coax outputs.

10. The non-contact type coaxial switch of claim 6, wherein a w.g. switch is a w.g. rotor that switches to input said waveguide to w.g. outputs.

11. The non-contact type coaxial switch of claim 6, wherein said non-contact type coaxial switch is essentially said coax switch that does not use any contact bars to transfer microwave energy between two connectors, it uses said rotor similar to said waveguide to transfer a signal between two connectors.

12. The non-contact type coaxial switch of claim 4, wherein said coax connectors work like an antenna and send a signal through a waveguide channel to a receiving connector.

13. The non-contact type coaxial switch of claim 2, wherein combining a signal between and after a waveguide transfer switch, said non-contact type coaxial switch is a compact device that allows for such switching capability above 26.5 GHz while being small and light weight.

14. The non-contact type coaxial switch of claim 2, wherein said non-contact type coaxial switch has a huge advantage of being contactless and more reliable at high frequencies and at high power.

15. The non-contact type coaxial switch of claim 9, wherein said non-contact type coaxial switch has a capability of switching between at least one of waveguide port(s) and coax input(s)/output(s).

16. The non-contact type coaxial switch of claim 15, wherein a plurality of possible combinations can be achieved by said non-contact type coaxial switch, whereby said switch is not only switching between two paths but these paths do not have to be the same they can include at least one of said waveguide port and said connector.

17. The non-contact type coaxial switch of claim 6, wherein said waveguide rotor in a bottom housing of said non-contact type coaxial switch pivots inside and is one of a fully-fledged rotor and one that has at least one of its sides cut out.

18. The non-contact type coaxial switch of claim 15, wherein said non-contact type coaxial switch allows for switching at higher frequencies with excellent performance; and
wherein said non-contact type coaxial switch can choose between a combination of one of waveguide ports and coaxial outputs.

19. The non-contact type coaxial switch of claim 2, wherein said non-contact type coaxial switch includes, a non-contact coax switch, a waveguide switch, and a hybrid between said non-contact coax switch and said a waveguide switch.

20. The non-contact type coaxial switch of claim 15, wherein said non-contact type coaxial switch can achieve two waveguide ports and 2 coax connectors.

21. The non-contact type coaxial switch of claim 15, wherein said non-contact type coaxial switch can achieve 3 connectors with 1 waveguide port configuration.

22. The non-contact type coaxial switch of claim 15, wherein said non-contact type coaxial switch can achieve said rotor and said housing with 2 waveguide ports.

23. The non-contact type coaxial switch of claim 22, wherein said non-contact type coaxial switch can achieve a flow of energy inside said housing from a coax to a coax.

24. The non-contact type coaxial switch of claim 22, wherein said non-contact type coaxial switch can achieve a flow of energy inside said housing from a coax to a waveguide port.

25. The non-contact type coaxial switch of claim 15, wherein said rotor is capable of switching to feed the coax outputs to form a waveguide switch with internal coax outputs.

26. The non-contact type coaxial switch of claim 15, wherein said non-contact type coaxial switch has two waveguide ports and 2 coax connectors.

27. The non-contact type coaxial switch of claim 15, wherein said non-contact type coaxial switch has 3 coax connectors with 1 waveguide port configuration.

28. The non-contact type coaxial switch of claim 22, wherein said non-contact type coaxial switch has said rotor and said housing with 2 waveguide ports.

29. The non-contact type coaxial switch of claim 22, wherein said non-contact type coaxial switch has a flow of energy inside said housing from a coax to a coax.

30. The non-contact type coaxial switch of claim 22, wherein said non-contact type coaxial switch has a flow of energy inside the housing from a coax to a waveguide port.
